(19) United States
(12) Patent Application Publication
(10) Pub. No.: US 2012/0180489 A1
(43) Pub. Date: Jul. 19, 2012

(54) FUEL INJECTOR

(75) Inventors: Mark Allan Hadley, Greer, SC (US); Jayaprakash Natarajan, Greer, SC (US)

(73) Assignee: GENERAL ELECTRIC COMPANY, Schenectady, NY (US)

(21) Appl. No.: 13/007,145

(22) Filed: Jan. 14, 2011

(51) Int. Cl. F02C 7/232; B05B 1/14

(52) U.S. Cl. 60/740; 239/548

(57) ABSTRACT

A fuel injector is provided and includes a first tube connectable with a vessel and second and third tubes to deliver fuel to an interior of the vessel, the second and third tubes being supported within the first tube such that the second and third tubes are offset in first and second opposing directions from a first plane of the first tube, respectively, and in a third direction from a second plane of the first tube, the first tube defining an annulus about the second and third tubes through which gas is deliverable to the vessel interior.

### BACKGROUND OF THE INVENTION

The subject matter disclosed herein relates to a fuel injector and, more particularly, to a fuel injector for a staged combustion process.

In gas turbine engines, combustible materials are combusted in a combustor and the high energy fluids produced by the combustion are directed to a turbine via a transition piece. In the turbine, the high energy fluids aerodynamically interact with and drive rotation of turbine blades in order to generate electricity. The high energy fluids are then transmitted to further power generation systems or exhausted as emissions along with certain pollutants, such as oxides of nitrogen (NOx) and carbon monoxide (CO). These pollutants are produced due to non-ideal consumption of the combustible materials.

Recently, efforts have been undertaken to achieve more ideal consumption of the combustible materials to thereby reduce the amounts of pollutants in the emissions. These efforts include the development of fuel injection whereby combustible materials are injected into the transition piece to mix with the main flow of high energy fluid moving through the transition piece toward the turbine. This leads to increased temperature and energy of the high energy fluids and more ideal consumption of fuel, which correspondingly reduces the pollutant emissions.

### BRIEF DESCRIPTION OF THE INVENTION

According to one aspect of the invention, a fuel injector is provided and includes a first tube connectable with vessel and second and third tubes to deliver fuel to an interior of the vessel, the second and third tubes being supported within the first tube such that the second and third tubes are offset in first and second opposing directions from a first plane of the first tube, respectively, and in a third direction from a second plane of the first tube, the first tube defining an annulus about the second and third tubes through which gas is deliverable to the vessel interior.

According to another aspect of the invention, a fuel injector is provided and includes a first tube connectable with a vessel and second and third tubes to deliver fuel to an interior of the vessel, the second and third tubes being supported within the first tube such that the second and third tubes are offset by like distances in first and second opposing directions from a central polar plane of the first tube, respectively, and by like distances in a third direction from a central equatorial plane of the first tube, the first tube defining an annulus about the second and third tubes through which gas is deliverable to the vessel interior.

According to yet another aspect of the invention, a gas turbine engine is provided and includes a vessel including a liner formed to define an interior through which a main flow travels and a fuel injector, including a first tube and second and third tubes to deliver fuel to the liner interior, the second and third tubes being supported within the first tube such that the second and third tubes are offset in first and second opposing directions from a first plane of the first tube, respectively, and in a third direction from a second plane of the first tube, the first tube defining an annulus about the second and third tubes through which gas is deliverable to the liner interior.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a fuel injector; and

FIG. 2 is an axial view of the fuel injector of FIG. 1.

The detailed description explains embodiments of the invention, together with advantages and features, by way of example with reference to the drawings.

### DETAILED DESCRIPTION OF THE INVENTION

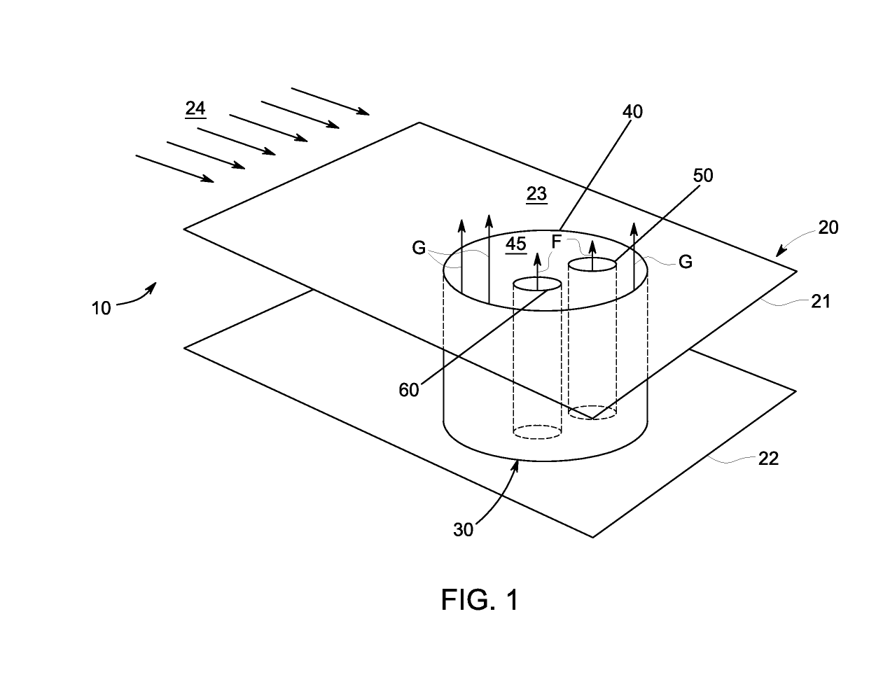

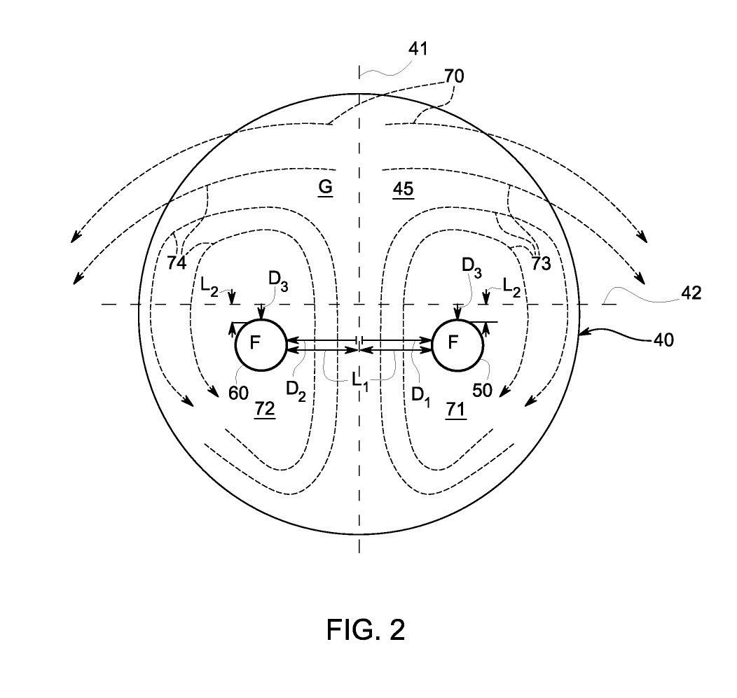

With reference to FIGS. 1 and 2, a portion of a gas turbine engine 10 is provided and includes a vessel, such as for example, a transition piece 20 and a fuel injector 30. The transition piece 20 includes a transition piece body or a liner 21. The liner 21 is formed to define an interior 23 through which a main flow 24 of high energy fluid produced by combustion in a combustor travels from the combustor, which is operably disposed upstream from the transition piece 20, to a turbine operably disposed downstream from the transition piece 20. A flow sleeve 22, which can be referred to as an impingement sleeve, may in some embodiments surround the liner 21.

The fuel injector 30 includes a first tube 40 and second and third tubes 50 and 60. The first tube 40 extends through the flow sleeve 22 to connect with the liner 21 or connects to both the flow sleeve 22 and the liner 21. The second and third tubes 50 and 60 are both configured to deliver injection fuel, F, to the interior 23 and are supported within the first tube 40. The injection fuel, F, delivered by each of the second and third tubes 50 and 60 may be similar or dissimilar to one another based on various considerations, such as fuel availability, turbine conditions and desired pollutant emission levels.

The second and third tubes 50 and 60 are supported within the first tube 40 such that the second and third tubes 50 and 60 are offset in first and second opposing directions, D₁ and D₂, from a first or polar plane 41 of the first tube 40, respectively, and in a third direction, D₃, from a second or an equatorial plane 42 of the first tube 40. The first tube 40 further defines an annulus 45 about the second and third tubes 50 and 60 through which gaseous matter, G, is deliverable to the interior 23.

Thus, the fuel injector 30 provides for staged combustion processes whereby some fraction of available fuel and air are combusted in a first stage of combustion and the fuel injector 30 provides the injection fuel, F, and air to a later stage or stages of combustion. In those later stage(s) of combustion, the products of the first stage combustion participate in the combustion of the injection fuel, F, and the air provided by the fuel injector 30. By reusing the products of combustion of the first stage in the later stage(s) in this manner, pollutant emission amounts can be decreased. The degree of this decrease can be amplified by use of multiple fuel injectors 30 arrayed around the liner 21 with respective connections to the liner 21, the flow sleeve 22 and/or both the liner 21 and the flow sleeve 22.

In accordance with embodiments, the first or polar plane 41 of the first tube 40 is defined substantially in parallel with respect to a direction of the main flow 24 and, in addition, may be the central polar plane as defined from the 12:00 position of the first tube 40 to the 6:00 position relative to the main flow 24 direction. Similarly, the second or equatorial plane 42 of the first tube 40 is defined substantially perpendicularly with respect to the main flow 24 direction and, in addition, may be the central equatorial plane as defined from the 9:00 position of the first tube 40 to the 3:00 position relative to the main flow 24 direction.

In a case where the polar plane 41 of the first tube 40 is the central polar plane, the offset of the second and third tubes 50 and 60 is directed substantially perpendicularly with respect to the main flow 24 direction and the second and third tubes 50 and 60 are each offset in the first and second directions, D₁ and D₂, from the polar plane 41 by substantially similar distances, L₁. Similarly, in a case where the equatorial plane 42 of the first tube 40 is the central equatorial plane, the offset of the second and third tubes 50 and 60 is directed downstream with respect to the main flow 24 direction and the second and third tubes 50 and 60 are each offset in the third direction, D₃, from the equatorial plane 42 by substantially similar distances, L₂.

With this construction, at the respective outlets of the first tube 40 and the second and third tubes 50 and 60, the velocity of the injection fuel, F, and the gaseous matter, G, as delivered to the interior 23 provides the injection fuel, F, and the gaseous matter, G, with an initial flow direction that is substantially perpendicular to that of the main flow 24. That is, the injection fuel, F, and the gaseous matter, G, are initially directed radially inwardly relative to the overall shape of the transition piece 20.

As shown in FIG. 2, however, at increasing distances from the liner 21, due to the fluid dynamics present within the interior 23, the gaseous matter, G, is forced into a dual vortex flow pattern 70 having a first vortex core 71 and a second vortex core 72 whereby a first portion 73 of the gas travels clockwise about the first vortex core 71 and a second portion 74 of the gas travels counter clockwise about the second vortex core 72. The second and third tubes 50 and 60 are supportively positioned within the first tube 40, as described above, such that they each deliver the injection fuel, F, toward and into the first vortex core 71 and the second vortex core 72, respectively. Since the first vortex core 71 and the second vortex core 72 are both relatively stable, a degree of mixing of the injection fuel, F, with the gaseous matter, G, and the components of the main flow 24 is thereby relatively increased from the axial location of the first tube 40 in the downstream direction. This leads to greater consumption of the combustible materials and relatively decreased pollutant emissions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel injector, comprising:
a first tube connectable with a vessel; and
second and third tubes to deliver fuel to an interior of the vessel, the second and third tubes being supported within the first tube such that the second and third tubes are offset in first and second opposing directions from a first plane of the first tube, respectively, and in a third direction from a second plane of the first tube,
the first tube defining an annulus about the second and third tubes through which gas is deliverable to the vessel interior.

2. The fuel injector according to claim 1, wherein the second and third tubes each deliver similar fuels to the vessel interior.

3. The fuel injector according to claim 1, wherein the second and third tubes each deliver dissimilar fuels to the vessel interior.

4. The fuel injector according to claim 1, wherein the first plane of the first tube is defined substantially in parallel with respect to a direction of a main flow through the vessel.

5. The fuel injector according to claim 4, wherein the first plane of the first tube is a central polar plane and the offset of the second and third tubes is directed substantially perpendicularly with respect to the main flow direction.

6. The fuel injector according to claim 1, wherein the second and third tubes are each offset in the first and second directions from the first plane by substantially similar distances.

7. The fuel injector according to claim 1, wherein the second plane of the first tube is defined substantially perpendicularly with respect to a direction of a main flow through the vessel.

8. The fuel injector according to claim 7, wherein the second plane of the first tube is a central equatorial plane and the offset of the second and third tubes is directed downstream with respect to the main flow direction.

9. The fuel injector according to claim 1, wherein the second and third tubes are each offset in the third direction from the second plane by substantially similar distances.

10. A fuel injector, comprising:
a first tube connectable with a vessel; and
second and third tubes to deliver fuel to an interior of the vessel, the second and third tubes being supported within the first tube such that the second and third tubes are offset by like distances in first and second opposing directions from a central polar plane of the first tube, respectively, and by like distances in a third direction from a central equatorial plane of the first tube,
the first tube defining an annulus about the second and third tubes through which gas is deliverable to the vessel interior.

11. A portion of a gas turbine engine, comprising:
a vessel including a liner formed to define an interior through which a main flow travels; and
a fuel injector, including:
a first tube; and
second and third tubes to deliver fuel to the liner interior, the second and third tubes being supported within the first tube such that the second and third tubes are offset in first and second opposing directions from a first plane of the first tube, respectively, and in a third direction from a second plane of the first tube,
the first tube defining an annulus about the second and third tubes through which gas is deliverable to the liner interior.

12. The portion of the gas turbine engine according to claim 11, wherein the first tube is connectable with the liner.

13. The portion of the gas turbine engine according to claim 11, wherein the second and third tubes each deliver similar fuels to the liner interior.

14. The portion of the gas turbine engine according to claim 11, wherein the second and third tubes each deliver dissimilar fuels to the liner interior.

15. The portion of the gas turbine engine according to claim 11, wherein the first plane of the first tube is defined substantially in parallel with respect to a direction of the main flow.

16. The portion of the gas turbine engine according to claim 15, wherein the first plane of the first tube is a central polar plane and the offset of the second and third tubes is directed substantially perpendicularly with respect to the main flow direction.

17. The portion of the gas turbine engine according to claim 11, wherein the second and third tubes are each offset in the first and second directions from the first plane by substantially similar distances.

18. The portion of the gas turbine engine according to claim 11, wherein the second plane of the first tube is defined substantially perpendicularly with respect to a direction of the main flow.

19. The portion of the gas turbine engine according to claim 18, wherein the second plane of the first tube is a central equatorial plane and the offset of the second and third tubes is directed downstream with respect to the main flow direction.

20. The portion of the gas turbine engine according to claim 11, wherein the second and third tubes are each offset in the third direction from the second plane by substantially similar distances.
